(19) United States
(12) Patent Application Publication
(10) Pub. No.: US 2014/0048213 A1
(43) Pub. Date: Feb. 20, 2014

(54) SLEEVELESS TIRE BUILDING DRUM WITH INTERCHANGEABLE WIDTH ELEMENTS

(71) Applicant: The Goodyear Tire & Rubber Company, Akron, OH (US)

(72) Inventors: Douglas Raymond Weaver, Uniontown, OH (US); Dennis Alan Lundell, Akron, OH (US)

(73) Assignee: The Goodyear Tire & Rubber Company, Akron, OH (US)

(21) Appl. No.: 13/774,118

(22) Filed: Feb. 22, 2013

Related U.S. Application Data
(60) Provisional application No. 61/683,242, filed on Aug. 15, 2012.

(51) Int. Cl. B29D 30/26

(52) U.S. Cl. CPC B29D 30/26
USPC 156/417

(57) ABSTRACT

A tire building drum and a method of building a tire carcass is disclosed. The tire building drum has a center section comprised of a plurality of segments that are radially and axially movable. The sleeve of the tire building drum over the center section has been eliminated, and instead has two seals located on the outer ends or shoulders of the center section of the tire building drum. The building drum further comprises shoulder sections that are axially movable. The shoulder sections include radially expandable bead locks. The method employs the steps of applying one or more carcass layers, locking the bead locks and moving the center section radially outwardly while moving the bead locks axially inwardly.

### FIELD OF THE INVENTION

The invention relates to a tire building drum, more particularly to a tire building drum with no center sleeve.

### BACKGROUND OF THE INVENTION

The manufacture of tires typically involves a tire building drum wherein numerous tire components are applied to the drum in sequence, forming a cylindrical shaped tire carcass. This stage of the tire building process is commonly referred to as the “first stage” of the tire building process. The tire carcass is then typically removed from the tire building drum and sent to a second stage, expandable tire shaping drum where the carcass is expanded into a toroidal shape for receipt of the remaining components of the tire such as the belt package and a rubber tread. The completed toroidally shape unvulcanized tire carcass or green tire is then removed from the second stage drum and subsequently molded and vulcanized into a finished tire.

The prior art process thus requires two tire building drums and the transfer of the carcass from one drum to the other. Further, a problem often arises in precisely locating and anchoring the tire beads on the unvulcanized tire carcass, especially during the transportation of the tire beads from the first stage drum to the second stage drum. Variations in bead positioning can result in ply distortion in the tire.

Tire manufacturers have recently begun moving towards the utilization of a single tire building drum, for both the first and second stage tire building. This requires that the tire building drum be capable of axial expansion and contraction as well as radial expansion/contraction. Further, it is important to maintain a positive bead lock during the entire tire building process, including the tire shaping, so that the ply cord length is maintained, resulting in good tire uniformity.

Tire manufacturers typically use a flexible cylindrical rubberized center sleeve as the outermost element on tire building drums. The center sleeve functions as the surface of application and point of fixation for the innermost component of the tire (innerliner). The section where the center sleeve wraps around the “shoulder” of the radially expansible segments also serves as a pneumatic seal against the bead area of the green tire, enabling inflation (shaping) of the green tire in the full-stage tire building process. The center sleeve also typically has a series of holes for providing a vacuum to secure the innerliner to the drum and the air to shape the green tire.

There are several disadvantages to the prior art rubber center sleeves. The tire building drums typically have a wide range of width adjustability, while the prior art rubber center sleeves have a very limited range of width operation, typically less than 30 mm. Thus the sleeve limits the action of the tire building drum, resulting in the need to change out the drum with another drum having a different width center sleeve in place. The necessity of changing out of the drum requires the storage of drums for different width sizes, and the loss in productivity during the drum change outs.

A second disadvantage to the prior art center sleeves is that during the tire building cycle the drum width is progressively reduced as the shaped diameter of the green tire increases. This reduced width action may result in the bunching up or buckling of the sleeve due to compression. As the buckled diameter is larger than the bead diameter of the tire, it is necessary to widen the width of the tire building drum in order to remove the finished tire from the drum.

A third disadvantage to the prior art center sleeves is that they are the highest maintenance component on the tire building drum, requiring frequent replacement when they become torn or blistered.

A fourth disadvantage to the prior art center sleeves is that the use of the sleeve results in an increased amount of force required to expand the drum.

A fifth disadvantage to the prior art center sleeves is that the use of the sleeve can result in uneven air flow distribution during inflation of the carcass, contributing to tire nonuniformity.

Thus it is desired to provide a tire building drum that overcomes the above described disadvantages.

### Definitions

For ease of understanding this disclosure, the following items are defined:

“Apex” means anelastomeric filler located radially above the bead and interposed between the plies and the ply turn-up.

“Axial” and “axially” means the lines or directions that are parallel or aligned with the longitudinal axis of rotation of the tire building drum.

“Bead” means that part of the tire comprising an annular tensile member commonly referred to as a “bead core” wrapped by ply cords and shaped, with or without other reinforcement elements such as flippers, chippers, apexes, toe guards and chafers, to fit the design rim.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing” means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire building drum.

“Radial Ply Tire” means a belted or circumferentially restricted pneumatic tire in which at least one layer of ply has the ply cords extend from bead to bead at cord angles between 65° and 90° with respect to the equatorial plane of the tire.

“Shoulder” means the upper portion of sidewall just below the tread edge.

“Sidewall” means that portion of a tire between the tread and the bead.

“Tread” means a rubber component which when bonded to a tire carcass includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1a is a perspective view of a tire building drum of the present invention shown having two shoulder sleeves mounted on the crown portion of the drum;

FIG. 1b is a perspective view of the tire building drum of FIG. 1a shown with the outer covering of the left and right hand side of the drums removed.

FIG. 2 is a front cross-sectional view of the tire building drum of FIG. 1 shown in the radially expanded position;

FIG. 3 is a close-up view of the center section of the tire building drum of FIG. 1;

FIG. 4 is a perspective view of the center section only shown in the radially expanded position;

FIG. 5 is a perspective view of a single center section segment;

FIG. 6 is a bottom view of the single center section segment of FIG. 8;

FIG. 7 is a perspective view of a single center section segment having a splice plate;

FIG. 8 is a bottom view of the single center section segment of FIG. 7 illustrating the bottom spring; and

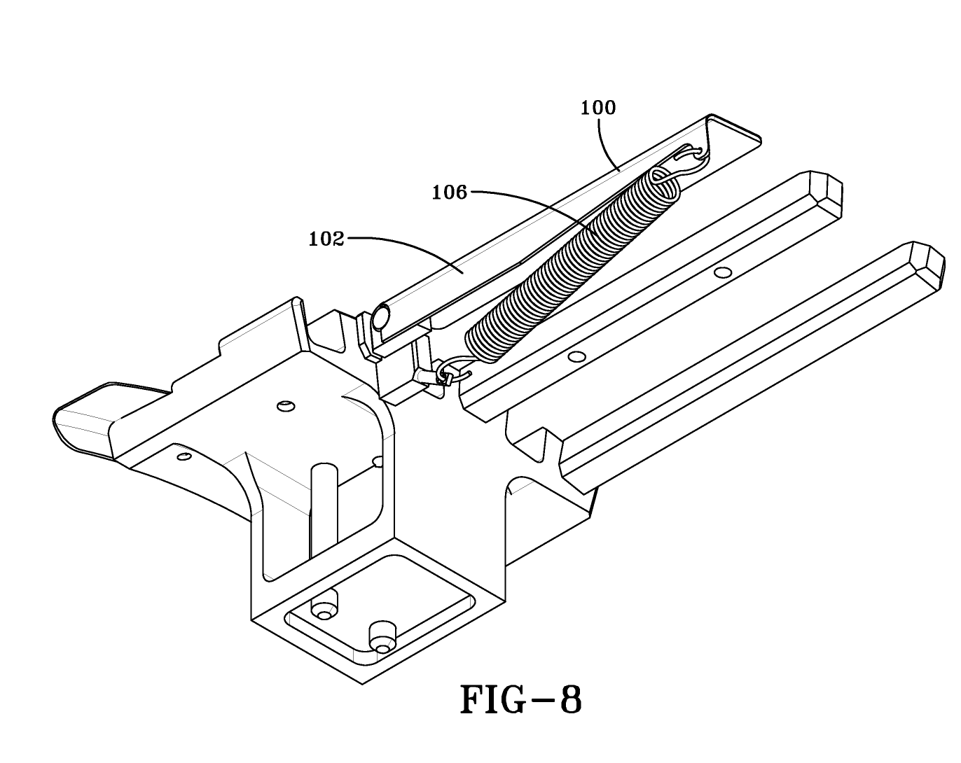

FIG. 9 is close up view of a portion of the center section showing the splice bar.

### DETAILED DESCRIPTION OF THE INVENTION

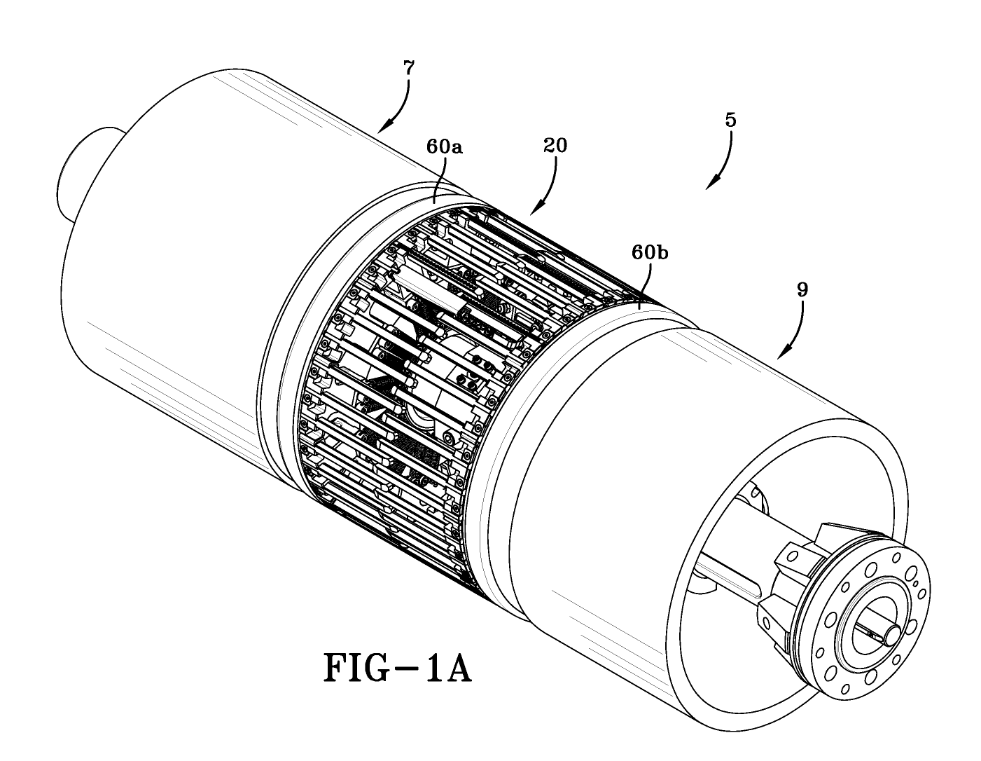

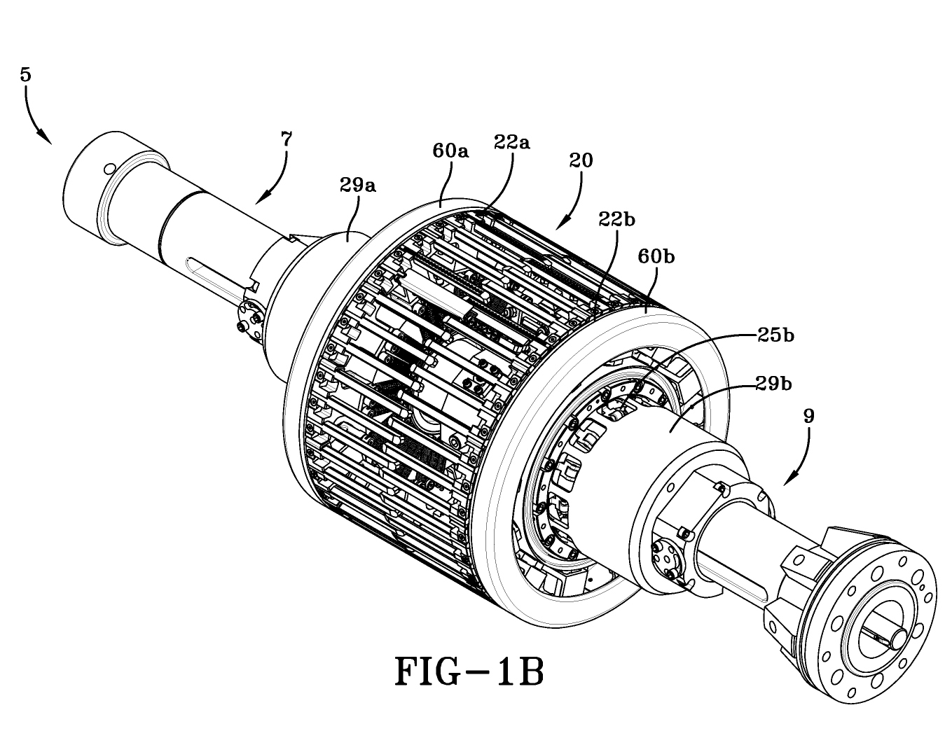

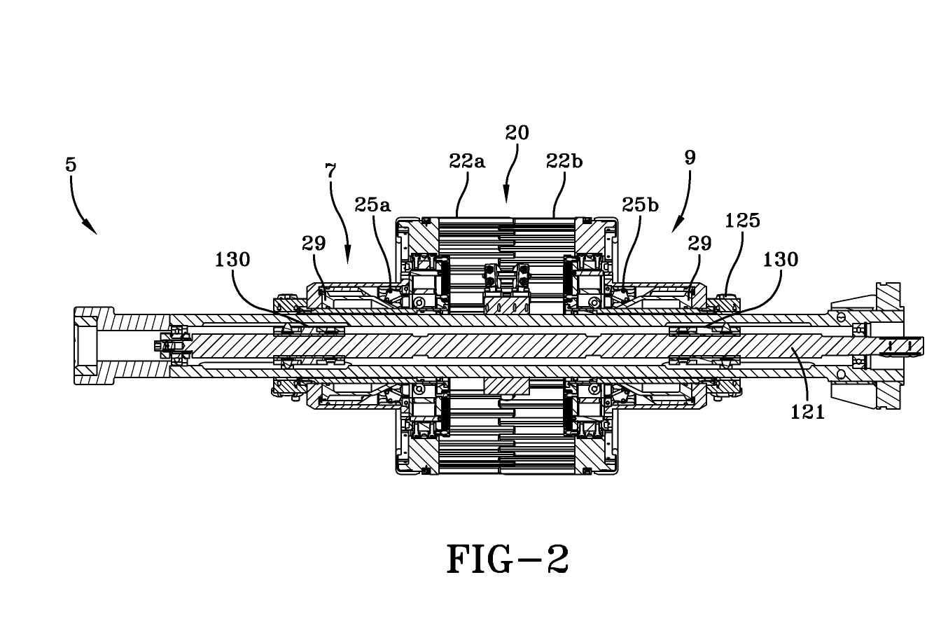

With reference to the Figures, an exemplary tire building drum 5 of the present invention is illustrated. As shown more particularly in FIGS. 1a and 1b, the tire building drum 5 has a left hand side 7 and a right hand side 9 joined together by a center section 20. The center section 20 is further divided into a right hand side 22b and a left hand side 22a, which are both axially and radially movable, as described in more detail, below. Adjacent the center section 20 are first and second bead locking mechanisms 25a,b, which are also radially movable as shown in FIG. 2. Adjacent the bead locking mechanisms are first and second shoulder sections 29. Both the bead locking mechanisms and the shoulder sections are axially movable and are driven by the center screw mechanism 121. Thus, both the left hand side and the right hand side of the drum are axially movable. These components are described in more detail, below.

### Center Section

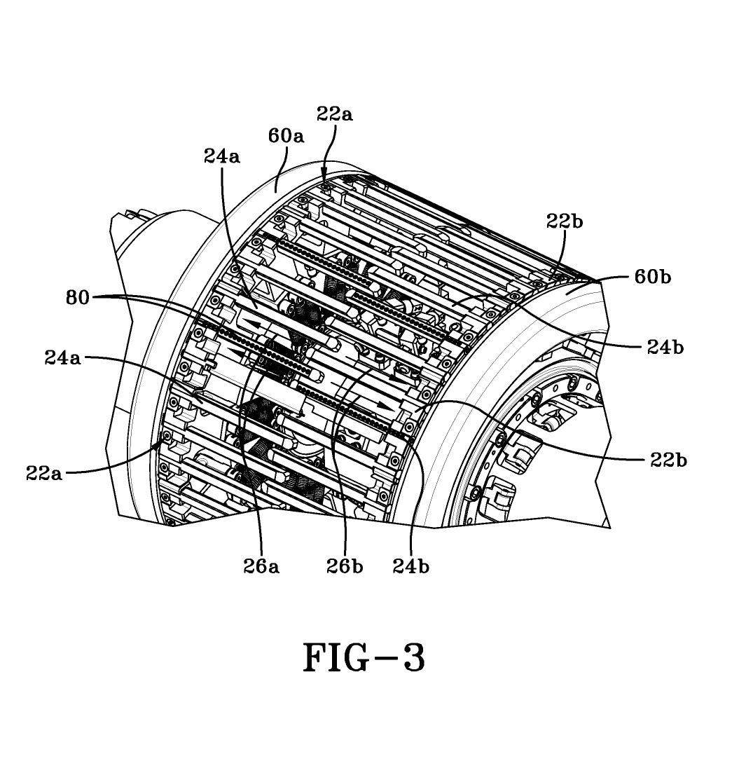

The center section 20 of the tire building drum, as shown in FIGS. 1-5, further comprises a plurality of center segments 22a,b located about the outer circumference of the drum. Each of the center segments may be further split into a left hand side 22a and a right hand side 22b, although not required. As shown in FIG. 3, the left hand side center segment 22a has one or more finger like projections or rods 24a, with recesses 26a located between the finger projections. The rods 24a slide in recesses 26b formed between fingers 24b. The right hand side is the mirror opposite. Thus the right hand side center segments 22b has one or more finger like projections or rods 24b that slide in recess 26a which are located between fingers 24a. Each of the finger like projections or rods 24a are received in a respective recess 42a,b of mounting block 40a,b. Thus the center section left hand side and the right hand side interdigitate or interlock like fingers of a folding hands in order to actuate the center section of the drum 20.

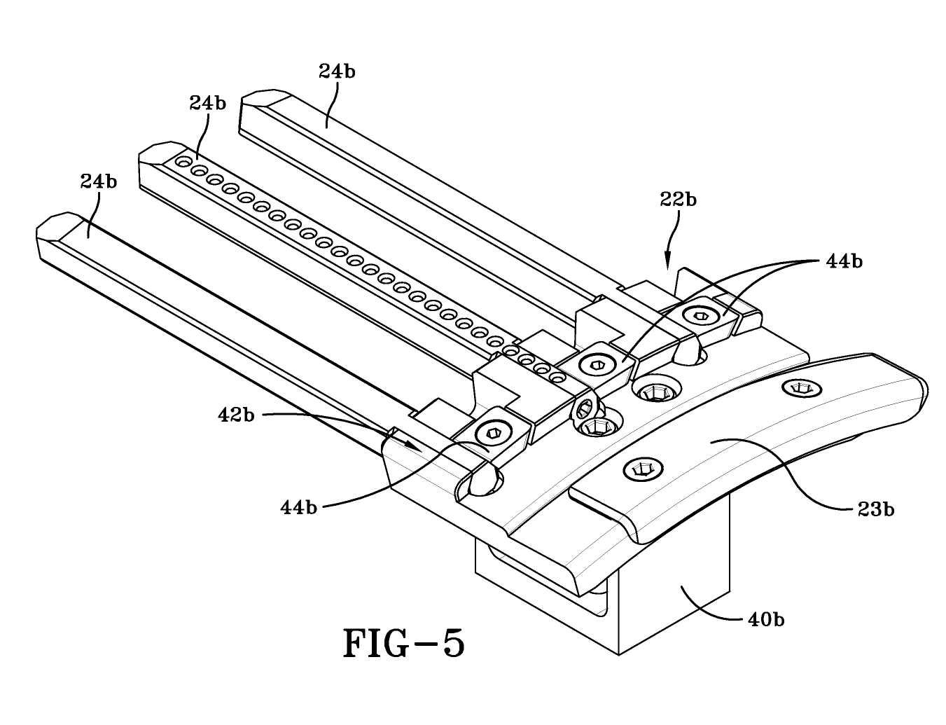

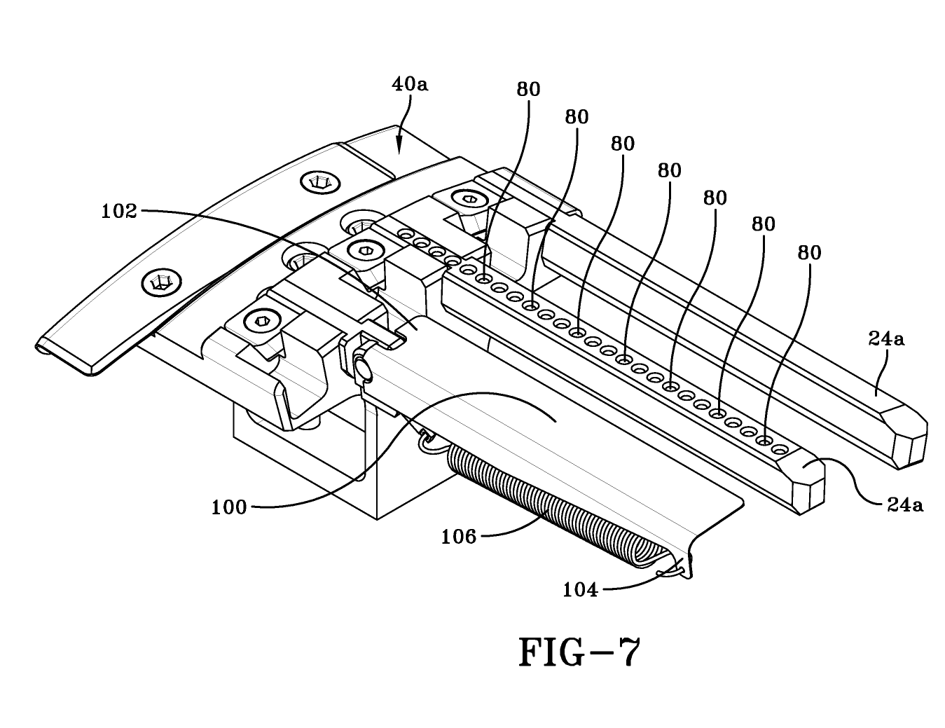

As shown in FIG. 5, a right hand center segment 22b is illustrated. The right hand center segment is shown having three finger like projections shaped like a rod 24b. Each rod 24b is received in recesses 42b of a mounting block 40b. The finger like projections 24b are secured within recess 42b of mounting block 40b via clamp 44b. A plurality of the mounting blocks 40a,b are arranged on opposite ends in an annular arrangement. The mounting blocks together with the finger like rods form the outer radial surface of the drum. The segments have been redesigned so that the innerliner is applied directly to the outer radial surface of the finger like rods instead of the center sleeve. Thus there is no center sleeve which extends over a portion or all of the outer radial surface of the drum. At least one finger of a segment (see FIG. 7) is equipped with holes 80 connected to a vacuum source to enable fixing the leading edge of the innerliner to the drum using vacuum. Preferably, a finger of each of a left segment and a right segment is equipped with the holes 80. The holes 80 may also be used to port air to inflate the tire into a toroid.

In order to have different size center sections, the radial height H of the mounting block may be increased or decreased as desired. The finger like projections having the same dimensions may be used interchangeably with mounting blocks of different radial dimensions in order to form drums of varying diameters. The interchangeability of the finger like projections reduce the amount of parts required to be kept in stock.

As shown in FIG. 3, left hand center segment 22a has three finger-like projections 24a which are slidably received in three elongate slots 26b formed between fingers 24b in an interdigitated or interlocked manner. Likewise, right hand center segment 22b has three finger like projections 24b which are slidably received in three opposed elongate slots 26a located between fingers 24a. The center segments 22a,b thus cooperate with each other to axially expand or contract as the fingers slide within the recesses.

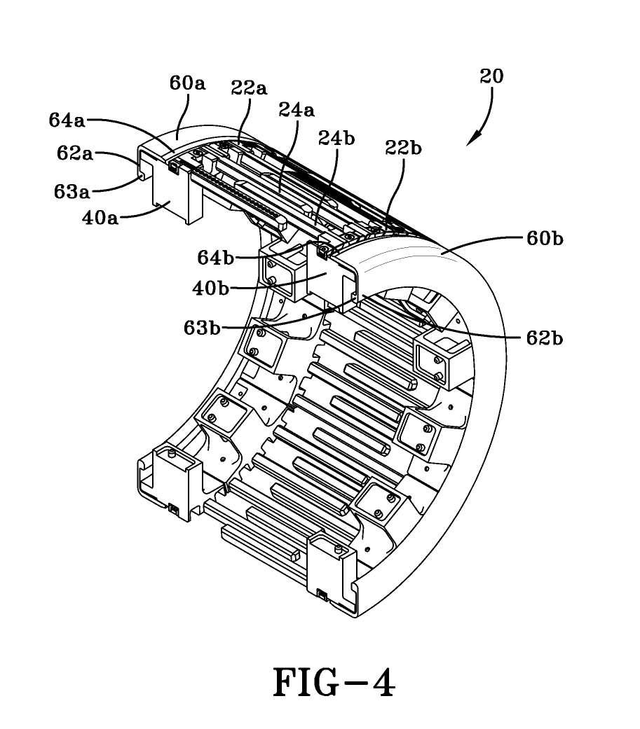

FIG. 4 shows the center section in the collapsed position. FIG. 2 illustrates the center section 20 in the radially expanded position. The center section 20 can radially expand in the range of about 20 to about 50 mm. As each center segment 22a,b radially expands, the gap between the fingers of the center segments increases.

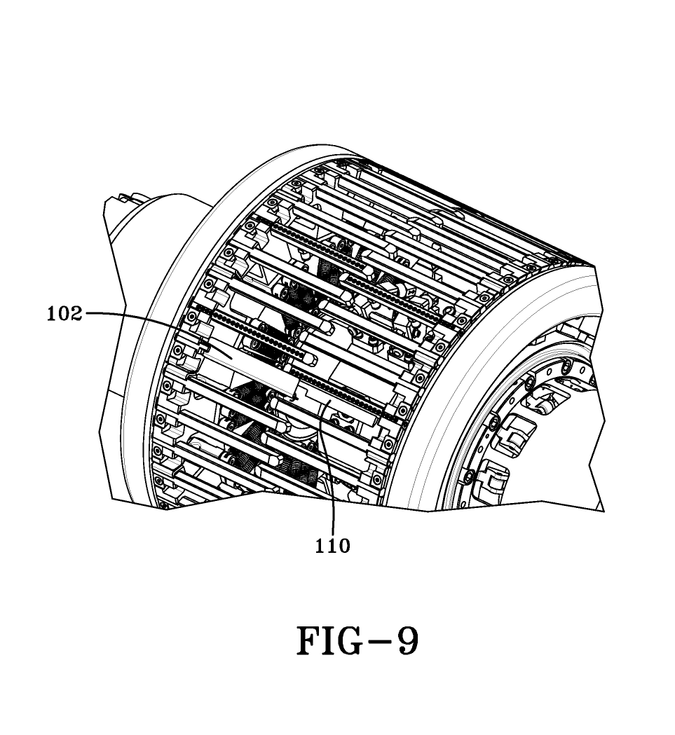

FIG. 7 further illustrates an optional feature of the tire building drum. FIG. 9 illustrates a resilient splice plate 100. The splice plate has a flat surface for performing a splice. The first end 102 of the splice plate is hinged. The second end 104 of the splice plate is connected to a spring 106. The second end 104 of the splice plate may be in engagement with a stationary splice plate 110 located on the second half of the center section as shown in FIG. 9. The stationary splice plate 110 supports the resilient splice plate 100.

### Shoulder Seals

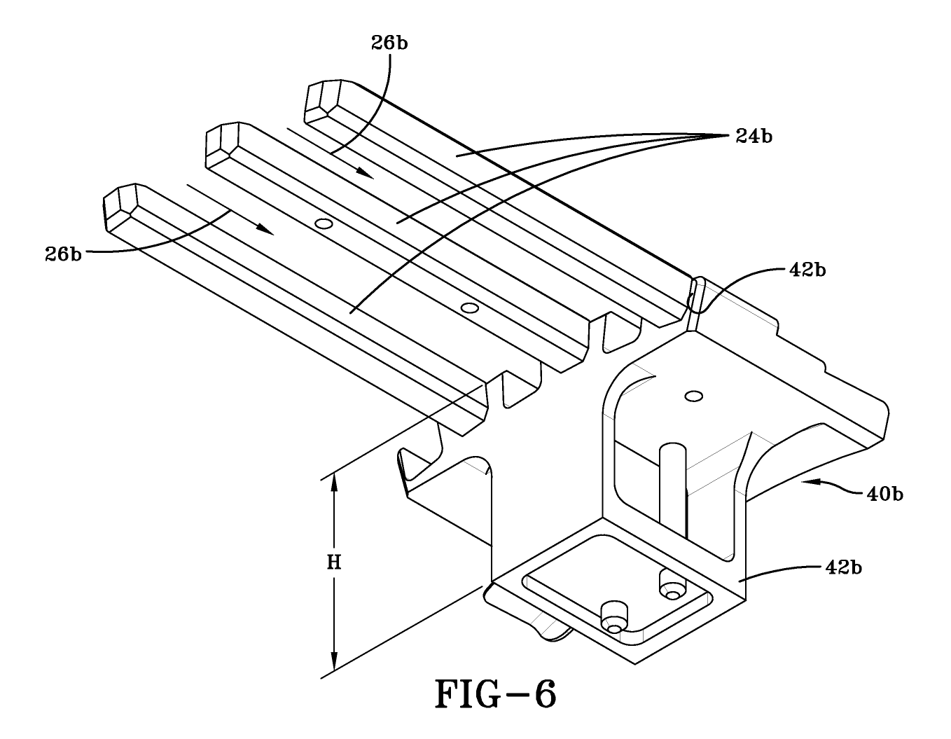

The tire building drum of the present invention does not have a center sleeve, nor a sleeve or any type of rubber component that extends from one end of the center section to the other end, nor a sleeve that is located in the center of the center section of the drum. The tire building drum of the present invention has eliminated the center sleeve, and includes a first and second shoulder seal 60a,b. The purpose of the shoulder seals is to maintain the pneumatic seal between the bead of the green tire and the tire building drum, enabling inflation and shaping of the green tire in the full stage tire building process. The first and second shoulder seal 60a,b are located on the axially outer ends of the segments 22a,b forming the center section. Each center seal preferably has an overall annular shape, having a first end 62a,b which is secured in seal clamps (not shown) located adjacent the center section segments. Preferably the first ends 62a,b of the seal have an outer bead projection 63 for mating reception with inner protrusion of the seal clamp. The shoulder seals each further comprise a second end 64a,b that is a free or unconstrained end. Thus the shoulder seals are not subject to axial tension which substantially reduced the life of the center sleeve. The free end 64a,b rests on the outer surface 23a,b (FIG. 6) of the center segments 22a,b, and will slide relative to the center segments when the drum is radially expanded. The outer surface 23a,b has a smaller outer diameter than the center of the center section, forming a radial step so that when the shoulder seals are mounted, the shoulder seals form a flush surface with the center section of the drum.

The shoulder seal is preferably molded into an L shape as shown in FIG. 4. The shoulder seal may be made of rubber or polyurethane or other flexible polymers.

### Bead Lock Mechanism

Adjacent the center section 20 are first and second annular bead locking mechanisms 25. FIG. 2 illustrates the bead locking mechanisms 25 in the retracted position.

### Shoulder Section and Shoulder Clamp Lock

The right and left hand shoulder section 29 of the tire building drum 5 is defined as the drum components located axially outward of the centerline of the center section, inclusive of the seal clamps and the bead lock mechanisms. The left and right hand shoulder sections of the tire building drum are axially slidable on bearing sleeves. The shoulder sections 29 are actuated by drive pins 125 mounted on nuts 130, which ride along drive screw 121. When the central screw is rotated, the nuts 130 move axially inward/outward, causing the drive pins 125 and each shoulder section to move axially inward/outward in corresponding fashion. In addition, the drive pins are also in mechanical cooperation with the split center segments, causing the split center segments 22a,b to axially extend or contract.

### Drive Shaft

A central drive shaft 120 is provided for rotational movement of the tire building drum 5 about its longitudinal axis. The central shaft 120 is connected to a drive means (not shown). Provided within the central drive shaft 120 is a central screw 121. The central screw 121 is supported at each end by bearings 123. The threads on one side of the central screw 121 are left handed and on the opposite side are right handed. On the left hand side is an inboard nut 125 connected to the one end of the threaded screw 121 and similarly on the opposite right hand side is an outboard ball nut 125 connected to the central screw 121.

### Turn Up Bladders

An upper bladder 150 extends axially outward from the bead lock mechanism 25 to the respective ends of the tire building drum. The upper bladder 150 extends over a lower bladder 152, which is mounted in the shoulder area of the drum and extends axially outward to the respective ends of the tire building drum. The upper and lower bladders function as turnup bladders which are used to inflate and, thereby, make the turn-up ends of the ply wrap about the apex and bead cores.

While certain representative embodiments and details have been shown for the purpose of illustrating the invention, it will be apparent to those skilled in this art that various changes and modifications may be made therein without departing from the spirit or scope of the invention.

What is claimed is:

1. A tire building drum comprising: a rotatable drum having a center section and a first and second shoulder section, said center section being radially expandable, wherein said center section has no center sleeve, wherein said center section has a first and second end, wherein the first and second end each have a shoulder, wherein the center section further comprises a first and second shoulder seal having a first end received in a clamp and a second free end slidable on the first and second end of the center section so that the shoulder seal extends over the shoulder of the center section.

2. The tire building drum of claim 1 wherein said center section segments further comprise a first half and a second half, wherein the first half is slidably mounted within the second half.

3. The tire building drum of claim 1 wherein the first half and the second half are each formed from one or more mounting blocks, wherein each mounting block has a recess for receiving one or more rods.

4. The tire building drum of claim 3 wherein the rods are removably secured to the mounting blocks.

5. The tire building drum of claim 3 wherein each mounting block has at least three rods separated by a recess, wherein the rods of the first half are aligned for reception into recesses of the second half.

6. The tire building drum of claim 3 wherein at least one rod has a plurality of holes.

7. The tire building drum of claim 3 wherein the mounting blocks have a radial height H and are interchangeable with mounting blocks having a different radial height.
